(19) United States
(12) Patent Application Publication
(10) Pub. No.: US 2007/0273460 A1
(43) Pub. Date: Nov. 29, 2007

(54) Polarizer

(76) Inventors: Tsung-Ying Chung, Taipei Hsien (TW); Jun-Zhe Huang, Taipei Hsien (TW); Chang-Hsiu Huang, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/634,234

(22) Filed: Dec. 6, 2006

(30) Foreign Application Priority Data
May 26, 2006 (TW) 95118828

(51) Int. Cl. H01P 1/165

(52) U.S. Cl. 333/21 A

(57) ABSTRACT

A polarizer includes a waveguide, a pair of ridges and a dielectric slab. The waveguide has a side wall. The ridges protrude from the inner surface of the side wall of the waveguide, and the ridges are substantially symmetric with respect to the central axis of the waveguide. The dielectric slab is positioned in the waveguide, and the dielectric slab is fastened by the pair of ridges.

### RELATED APPLICATIONS

The present application is based on, and claims priority from, Taiwan Application Serial Number 95118828, filed May 26, 2006, the disclosure of which is hereby incorporated by reference herein in its entirety.

### BACKGROUND

1. Field of Invention

The present invention relates to a polarizer. More particularly, the present invention relates to a polarizer for circularly polarizing signals.

2. Description of Related Art

Since the first artificial space satellite was sent into orbit in 1957, satellites have played an important role in international communication. Accordingly, satellite communication has made communication more convenient due to the recent popularization of satellite communication.

However, both launching and manufacturing satellites are very costly. Therefore, circular polarization and linear polarization has been developed to fully utilize the limited bandwidth provided by the satellites. That is, a phase difference between two orthogonal electric field components of a signal is employed to increase the available bandwidth of satellites.

Waveguide polarizers are used to convert a linearly polarized input signal into a circularly polarized output signal. Generally, waveguide polarizers operate by separating an input signal into two orthogonal electric field components, and then one of which is delayed relative to the other to introduce a phase difference of 90 degrees, that is, the waveguide polarizers convert the input signal into a circularly polarized output signal. Typically, the length of the waveguide polarizers should be long enough to achieve a 90 degree difference. However, such a long waveguide polarizer is inconvenient to assemble and use. In addition, it is very difficult to produce a waveguide polarizer with a wide bandwidth or with multiple bands because the phase delay of a signal component varies according to the wavelength of the input signal.

For the forgoing reasons, there is a need for a small-sized waveguide polarizer with a wide bandwidth or with multiple bands.

### SUMMARY

In accordance with the present invention, a polarizer includes a waveguide, a pair of ridges and a dielectric slab. The waveguide has a side wall. The ridges protrude from the inner surface of the side wall of the waveguide, and the ridges are substantially symmetric with respect to the central axis of the waveguide. The dielectric slab is positioned in the waveguide, and the dielectric slab is fastened by the pair of ridges.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A and FIG. 1B are a three dimensional view and a sectional view of a polarizer according to one preferred embodiment of this invention; and

FIG. 2 is a top view showing the first ridge 121 of FIG. 1B;

FIG. 3A and FIG. 3B are diagrams showing simulation curves of phase difference vs. frequency for a polarizer according to one preferred embodiment of the present invention, wherein the phase difference is between the vertical electric field signal component and the horizontal electric field signal component of the output signal outputted by the polarizer;

FIG. 4A is a diagram showing a measured curve of phase difference vs. frequency for a polarizer according to one preferred embodiment of the present invention, wherein the phase difference is between the vertical electric field signal component and the horizontal electric field signal component of the output signal outputted by the polarizer; and

FIG. 4B is a diagram showing a measured curve of axial ratio vs. frequency for a polarizer according to one preferred embodiment of the present invention.

### DESCRIPTION OF THE PREFERRED EMBODIMENTS

The present invention provides a polarizer with ridges and a dielectric slab to have another band, broaden the bandwidth and reduce the size of the polarizer. Reference will now be made in detail to the present preferred embodiments of the invention, examples of which are illustrated in the accompanying drawings. Wherever possible, the same reference numbers are used in the drawings and the description to refer to the same or like parts.

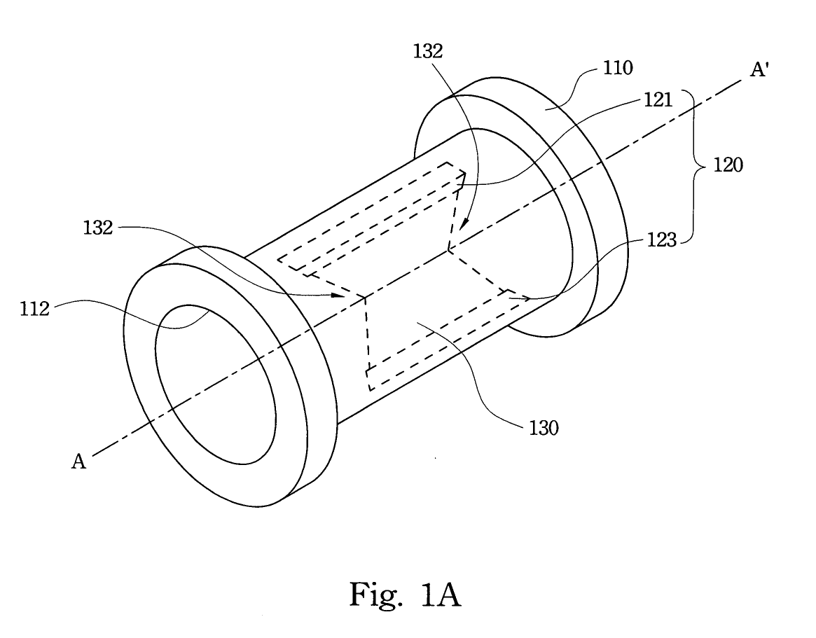

Refer to FIG. 1A and FIG. 1B. FIG. 1A and FIG. 1B show a three dimensional view and a sectional view of a polarizer according to one preferred embodiment of this invention. In FIG. 1A and FIG. 1B, a polarizer includes a waveguide 110, a pair of ridges 120 and a dielectric slab 130. The waveguide 110 has a side wall, and the diameter of the waveguide 110 is determined by the lower band of the polarizer. The ridges 120 include a first ridge 121 and a second ridge 123. The first ridge 121 and the second ridge 123 protrude from the inner surface 112 of the side wall of the waveguide 110, and the first ridge 121 and the second ridge 123 are substantially symmetric with respect to the central axis A-A′ of the waveguide 110. The dielectric slab 130 is positioned in the waveguide 110, and the dielectric slab 130 is fastened by the pair of ridges 120. The electric field component parallel to ridges 120 and dielectric slab 130 is delayed compared to the electric field component that is perpendicular to ridges 120 and dielectric slab 130.

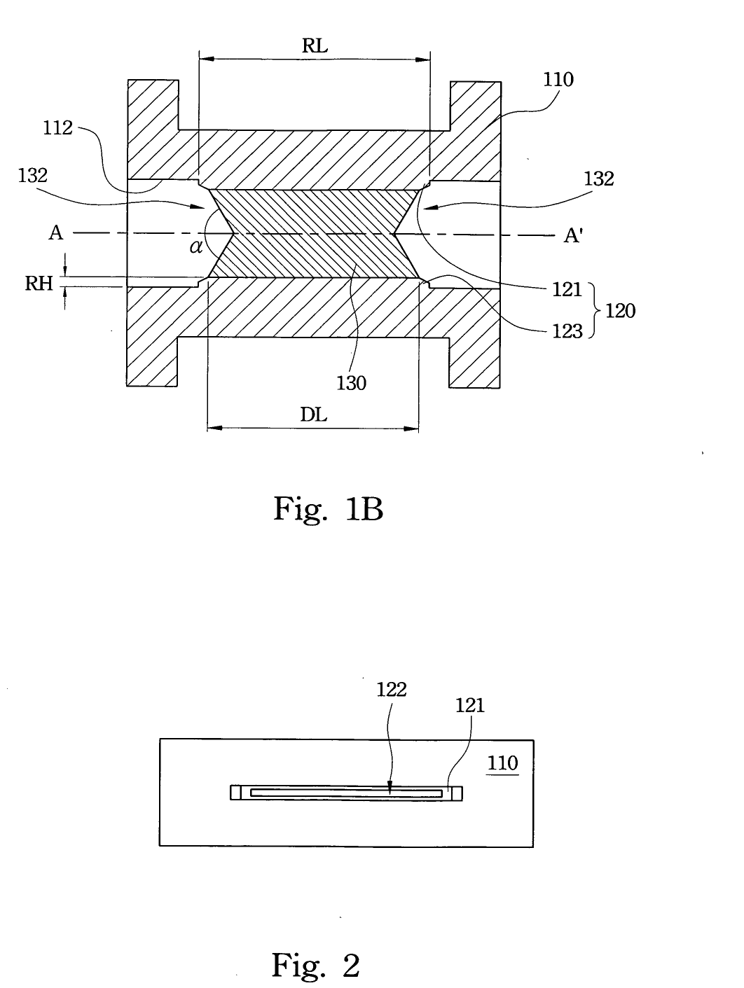

Refer to FIG. 2. FIG. 2 is a top view showing the first ridge 121 of FIG. 1B. In this embodiment, the first ridge 121 may have a socket 122 to fix the dielectric slab. More specifically, the dielectric slab (130 shown in FIG. 1B) may be inserted into the socket 122. Similarly, the second ridge (123 shown in FIG. 1B) may have a socket to fix the dielectric slab as well.

Refer to FIG. 1B. Both the ridges 120 may be extended in parallel with the central axis A-A′ of the waveguide 110. In addition, the dielectric slab 130 may be extended in parallel with the central axis A-A′ of the waveguide 110 as well. Because the input signal progresses along the central axis A-A′ of the waveguide 110, each of the ridges 120 and the dielectric slab 130 should be extended in parallel with the central axis A-A′ of the waveguide 110 to have a better phase delay effect.

Continue to refer to FIG. 1B. Two edges of the dielectric slab 130 are respectively defined a notch 132, and the central axis A-A′ of the waveguide 110 intersects the notches 132. Accordingly, the input signal can have a gradual medium transition in the polarizer, and hence the return loss can be reduced. Generally, each of the notches 132 are formed with an opening angle α, and the smaller the opening angle α is, the smaller the return loss of the polarizer is. On the contrary, if the opening angle α approaches 180 degrees, the input signal will suffer serious medium transition in the polarizer, and hence the return loss will be increased as well. In this embodiment, the opening angle α of each of the notches 132 may be 73 degrees.

In addition, the length RL and the height RH of the ridges 120 would affect the return loss, phase difference and amplitude difference. Generally, the higher the height RH of the ridges 120 is, the more unstable the return loss is, the larger the phase difference of the output signal is, and the narrower the bandwidth of the polarizer available with a specific amplitude difference range is. However, the length RL and the height RH of the ridges 120 are complementary. Therefore, if the height RH of the ridges 120 is decreased, the length RL of the ridges 120 will be increased to introduce a phase difference of 90 degrees. In this embodiment, the height RH of the ridges 120 may be about 1 mm, and the length RL of the ridges 120 may be about 23 mm.

Similarly, the length DL and the thickness of the dielectric slab 130 would affect the return loss, phase difference and amplitude difference as well. Generally, the thicker the thickness of the dielectric slab 130 is, the more unstable the return loss is, the larger the phase difference of the output signal is, and the narrower the bandwidth of the polarizer available with a specific amplitude difference range is. However, the length DL and the thickness of the dielectric slab 130 are complementary. Therefore, if the thickness of the dielectric slab 130 is decreased, the length DL of the dielectric slab 130 will be increased to introduce a phase difference of 90 degrees. Note that, the length RL of the ridges 120 may be larger than the length DL of the dielectric slab 130. In this embodiment, the thickness of the dielectric slab 130 may be about 0.5 mm, and the length DL of the dielectric slab 130 may be about 19 mm.

The following examples illustrate the effect of the polarizer according to the mentioned embodiments of the present invention. The following examples show the embodiments can indeed circularly polarize signals with a wide bandwidth or with multiple bands. This is because the lower the frequency of the input signal is, the more the phase delay due to the ridges is, while the less the phase delay due to the dielectric slab is. Therefore, the polarizer according to mentioned embodiments of the present invention combines the ridges and the dielectric slab to circularly polarize signals with dual bands.

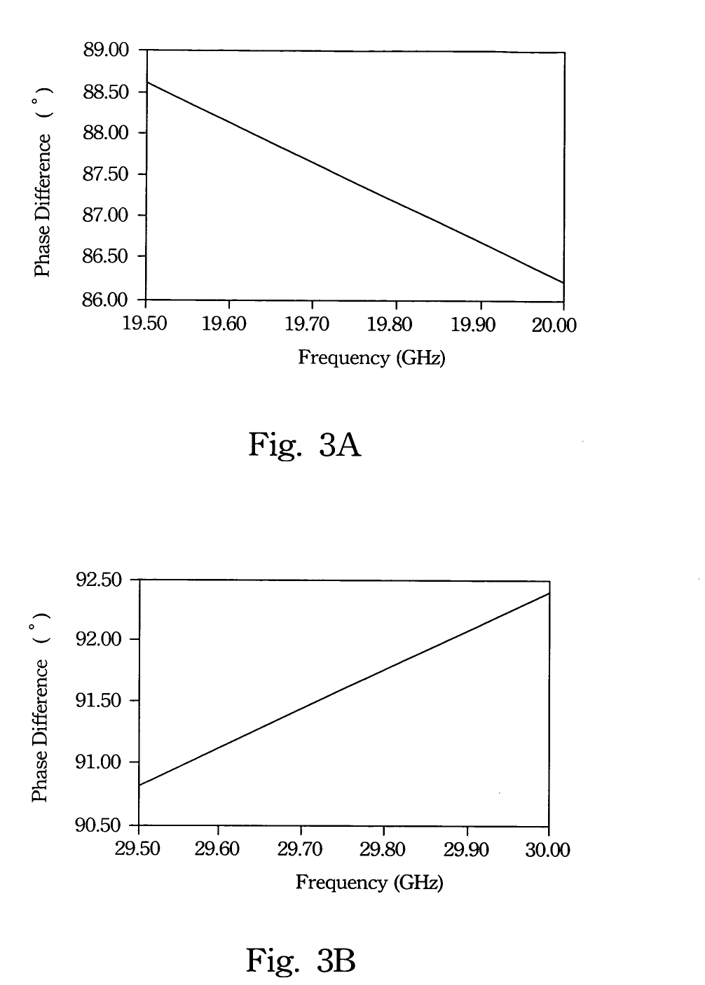

Refer to FIG. 3A and FIG. 3B. FIG. 3A and FIG. 3B show simulation curves of phase difference vs. frequency for the polarizer according to the mentioned embodiments of the present invention, wherein the phase difference is between the vertical electric field signal component and the horizontal electric field signal component of the output signal outputted by the polarizer. More specifically, the frequency range shown in FIG. 3A is 19.5-20 GHz, and the frequency range shown in FIG. 3B is 29.5-30 GHz. As shown in FIG. 3A and FIG. 3B, when an input signal with a frequency of 20 GHz is inputted into the polarizer, the polarizer converts it into an output signal with a phase difference slightly less than 90 degrees. Furthermore, when an input signal with a frequency of 30 GHz is inputted into the polarizer, the polarizer converts it into an output signal with a phase difference slightly larger than 90 degrees. In conclusion, whether the input signal is 20 GHz or 30 GHz, the polarizer according to this preferred embodiment of the invention can convert it into a circularly polarized output signal, that is, a phase difference between a vertical electric field signal component and a horizontal electric field signal component of the output signal is within 90±5 degrees.

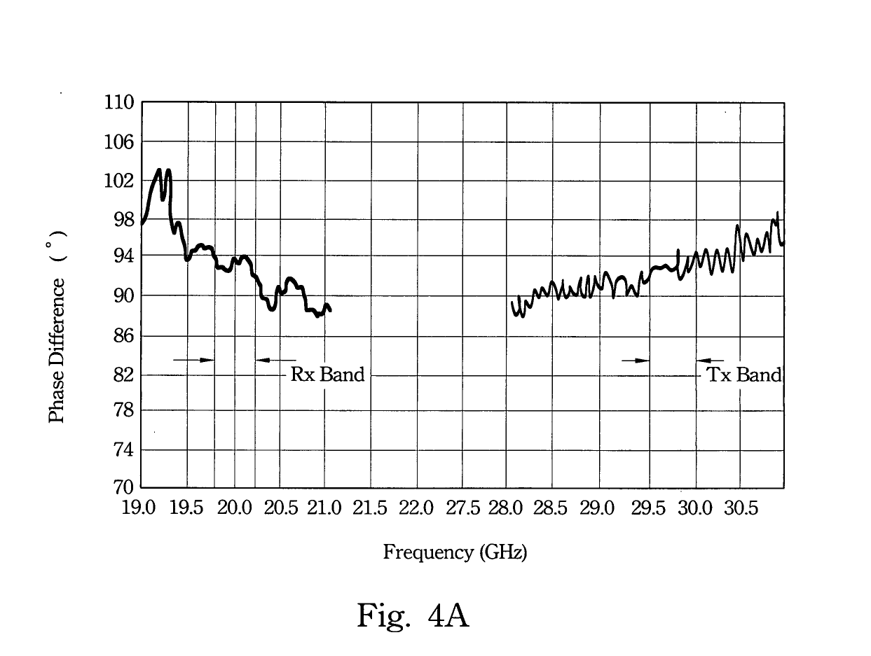

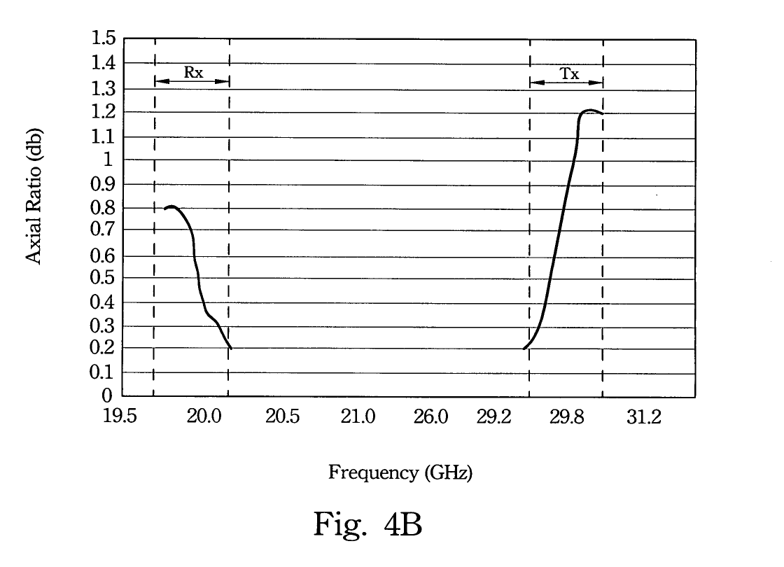

Reference is made to FIG. 4A and FIG. 4B. FIG. 4A is a diagram showing a measured curve of phase difference vs. frequency for the polarizer according to the mentioned embodiment of the present invention, wherein the phase difference is between the vertical electric field signal component and the horizontal electric field signal component of the output signal outputted by the polarizer. FIG. 4B is a diagram showing a measured curve of axial ratio vs. frequency for the polarizer according to the mentioned embodiment of the present invention. As shown in FIG. 4A and FIG. 4B, when an input signal with a frequency of about 20 GHz or about 30 GHz is inputted into the polarizer, the polarizer converts it into an output signal with a phase difference within 90±5 degrees, and the axial ratio of the output signal is less than 1.2 db as well. As stated above, the polarizer can circularly polarize signals with dual bands.

In conclusion, the invention has at least the following advantages:

(1) The polarizer according to the mentioned embodiments of the present invention can delay the electric field component parallel to ridges and dielectric slab because the ridges and the dielectric slab are positioned in the waveguide.

(2) The length of the polarizer according to the mentioned embodiments of the present invention can be shorter than prior art because the ridges and the dielectric slab simultaneously delay the electric field component parallel to ridges and dielectric slab.

(3) The polarizer according to the mentioned embodiments of the present invention can circularly polarize signals with dual bands. This is because the lower the frequency of the input signal is, the more the phase delay due to the ridges is, while the less the phase delay due to the dielectric slab is.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A polarizer comprising:
a waveguide having a side wall;
a pair of ridges protruding from the inner surface of the side wall of the waveguide and substantially symmetric with respect to the central axis of the waveguide; and
a dielectric slab positioned in the waveguide and fastened by the ridges.

2. The polarizer of claim 1, wherein each of the ridges has a socket, and the dielectric slab is inserted into the sockets.

3. The polarizer of claim 1, wherein each of the ridges is extended in parallel with the central axis of the waveguide.

4. The polarizer of claim 1, wherein the dielectric slab is extended in parallel with the central axis of the waveguide.

5. The polarizer of claim 1, wherein two edges of the dielectric slab are respectively defined a notch, and the central axis of the waveguide intersects the notches.

6. The polarizer of claim 5, wherein each of the notches formed with an opening angle of about 73 degrees.

7. The polarizer of claim 1, wherein each of the ridges protrudes from the inner surface of the side wall at a height of about 1 mm.

8. The polarizer of claim 1, wherein the length of each of the ridges is larger than the length of the dielectric slab.

9. The polarizer of claim 1, wherein the length of each of the ridges is about 23 mm.

10. The polarizer of claim 1, wherein the length of the dielectric slab is about 19 mm.

11. The polarizer of claim 1, wherein the thickness of the dielectric slab is about 0.5 mm.
